(19) United States
(12) Patent Application Publication
(10) Pub. No.: US 2005/0222952 A1
(43) Pub. Date: Oct. 6, 2005

(54) System and method for real-time account validation for an on-line payment system

(76) Inventors: Dave Garrett, Lincroft, NJ (US); Dario Vergara, Fort Lee, NJ (US); Joan Stem, Easton, PA (US); Dan Snyder, Belle Mead, NJ (US)

Correspondence Address: WILMER CUTLER PICKERING HALE AND DORR LLP, 399 PARK AVENUE, NEW YORK, NY, 10022, US

(21) Appl. No.: 10/923,936

(22) Filed: Aug. 23, 2004

Related U.S. Application Data
(60) Provisional application No. 60/557,701, filed on Mar. 31, 2004.

(51) Int. Cl. G06F 17/60

(52) U.S. Cl. 705/40

(57) ABSTRACT

An on-online payment system with real-time account validation is provided. The present invention provides consumers to ability to enroll in the payment system, to add payees, and to manage payees (including editing and deletion of payees). Consumers may also view payment histories, and make new payments (either one time or recurring). Before provide payment to a payee, a real-time call is placed into a Bill Payment Processor's Account Validation System in order to validate the Biller information that has been entered by a consumer. If the Biller information is incorrect, the consumer is prompted to correct it. As a result, the information collected from the consumer is more accurate, and payments are less likely to be rejected.

### CROSS REFERENCE TO RELATED APPLICATION

This application claims the benefit under 35 U.S.C. § 119(e) of U.S. Provisional Patent Application No. 60/557,701, filed Mar. 31, 2004, which is hereby incorporated by reference herein in its entirety.

### FIELD OF THE INVENTION

The present invention is directed to an on-line bill payment system and method and, in particular, an on-line bill payment and services system and method that performs real-time account validation.

### BACKGROUND OF THE INVENTION

Internet Bill Pay, which is sometimes referred to as online bill payment, is a mechanism that allows consumers to pay their bills via the Internet. A consumer, sitting at his or her own personal computer, may access the web site of a provider and pay bills thereby eliminating the need to write traditional checks. This service may be offered by, for example, financial institutions, such as a bank to their consumer. In the Internet Bill Pay context, the financial institution or Service Provider is typically referred to as the Originator. Consumers enroll in the service and establish a list of Billers (sometime referred to as payees) by providing the biller name, remittance address and their account number with the Biller. Once a Biller has been established on the service, the consumer can then schedule payments to be made to the Biller on their behalf. Based upon the instructions given by the consumer, the Bill Payment Service Provider makes the consumer's bill payments.

Historically when a consumer uses their Originator's Internet Bill Pay service, she would enter the Biller information that she would like to pay and then initiate a payment to that Biller. The consumer would not know whether the Biller information she entered was correct or incorrect until the payment was processed and was either rejected by the payment processor or was sent to the Biller and was rejected at that time. In either case, the lack of Biller account validation caused delays in payment posting and resulted in consumer dissatisfaction with Internet Bill Pay services. Thus there is a need to validate account information entered by a consumer in a manner so that the consumer could take corrective action and avoid delays in payment postings.

### SUMMARY OF THE INVENTION

In accordance with the present invention, an on-online payment system with real-time account validation is provided. According to the invention, before payment to a biller is made, a real-time call is placed into a Bill Payment Processor's Account Validation System in order to determine whether the biller information entered by a consumer is correct. If the Biller information is incorrect, the consumer is prompted to correct it. As a result, the information collected from the consumer is more accurate, and payments are less likely to be rejected.

In one embodiment, the invention provides a method for operating an electronic payment system that includes receiving a user's payee information, validating the user's payee information using an account validation system, and storing the user's payee information only if the validation was a success.

In a second embodiment, the invention provides a method for initiating payment to a biller using an electronic payment system, wherein the payment is based on a user's payee information, and the method includes receiving the user's payee information by a bill payment processor of the electronic payment system, validating the user's payee information using an account validation system of the bill payment processor, and submitting payment to the biller upon a request by the user if the validation of the user's payee information was a success.

In a third embodiment, the invention provides a method for operating an electronic payment system that includes entering a user's payee information to a service provider of the electronic system, providing the user's payee information, from the service provider, to a bill payment processor of the electronic payment system, validating the user's payee information by an account validation system of the bill pay processor, storing the user's payee information in a bill pay profile of the user only if the validation was a success, and submitting payment to a payee at the request of the user based on the user's payee information that has been stored in the bill pay profile of the user.

In a fourth embodiment, the invention provides an electronic payment system that includes a bill payment processor for receiving a user's payee information, wherein the bill payment processor has an account validation system for validating the user's payee information, and means for providing payment to the payee upon a request by the user if the validation of the user's payee information was a success.

### BRIEF DESCRIPTION OF THE DRAWINGS

Additional embodiments of the invention, its nature and various advantages, will be more apparent upon consideration of the following detailed description, taken in conjunction with the accompanying drawings, in which like reference characters refer to like parts throughout:

FIG. 1 illustrates a high level overview of an exemplary online bill payment service provider system;

FIGS. 2A through 2E provide additional detail of the components of the exemplary online bill payment service provider system illustrated in FIG. 1;

FIG. 3 illustrates an exemplary system environment for implementing the present invention;

FIG. 4 illustrates an exemplary process flow for the present invention;

FIG. 5 illustrates an exemplary embodiment of an Input Request Document Type Definition (“DTD”);

FIG. 6 illustrates an exemplary embodiment of an Input Request Data Dictionary;

FIG. 7 illustrates an exemplary embodiment of a Response DTD;

FIG. 8 illustrates an exemplary embodiment of a Response Data Dictionary; and

FIG. 9 illustrates an exemplary embodiment of Status Codes and Descriptions that are received in the Response DTD.

### DETAILED DESCRIPTION OF INVENTION

In the following detailed description, numerous specific details are set forth regarding the system and method of the present invention and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are exemplary. It is contemplated that there are other methods and systems that are within the scope of the present invention.

The present invention provides a real-time call into a Bill Payment Processor's Account Validation System. This real-time call enables a consumer to be notified in real-time if the biller information that she entered is correct or incorrect and if her payments will be processed electronically or via check.

The invention changes the prior art approach to account validation process by performing a real-time validation of the Biller account number at the point that the consumer is entering the Biller information. If the Biller information is incorrect, the consumer is prompted to correct it. This prevents a payment from being initiated by the consumer to an invalid destination. The invention provides a mechanism for accessing an account validation system in real-time to validate payee information entered by Originator's consumers while they are establishing or modifying Biller information.

Using this service improves system performance and the consumer experience in several ways. First, the information collected from the consumer is more accurate. Major errors such as an incorrect Biller account number or remittance address can be caught and corrected before payments are sent to be processed. If these types of errors are not caught, they will cause the payments to be rejected. Additionally, minor typographical errors and extraneous characters—which may or may not cause a payment to be rejected—can be screened and corrected as well. This in turn will increase the success rate of electronic payments, which will travel to the payee faster, are less likely to result in consumer complaints and will increase the overall customer satisfaction with Internet Bill Pay services.

The present invention can be integrated into an Originator's Internet Bill Pay Service. Alternatively, as would be understood by one skilled in the art, the present invention can be a separate process invoked at appropriate times by the Originator's Internet Bill Pay Service. In either scenario, the functionality of the present invention is independent of how the Internet Bill Pay Service functions, since it is only accessed at the time the Internet Bill Pay Service sends a call to the Bill Payment Processor's account validation system. Furthermore, how the response to the validity of the account number is utilized depends solely on the Internet Bill Pay Service and would be well understood by those skilled in the art.

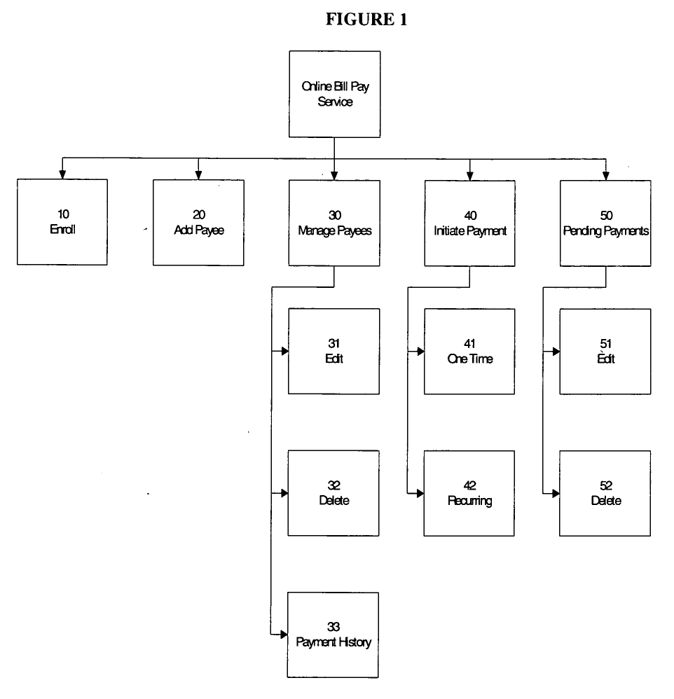

Referring now to the drawings, and initially to FIG. 1, there is illustrated an exemplary online bill payment service provider's system. The system depicted contains the basic components that are needed for a Bill Pay Service. The figure is exemplary and is not meant to represent an example of all Online Bill Services.

FIG. 1 illustrate the five components that typically comprise a Bill Pay Service: Enrollment 10, the ability to add payees 20, the ability to manage payees 30, including the ability to Edit 31, Delete 32, View History 33, Make payments 40, including the ability to make One Time payments 41 and Recurring payments 42, and to View pending payments 50, including the ability to Edit 51 and Delete 52.

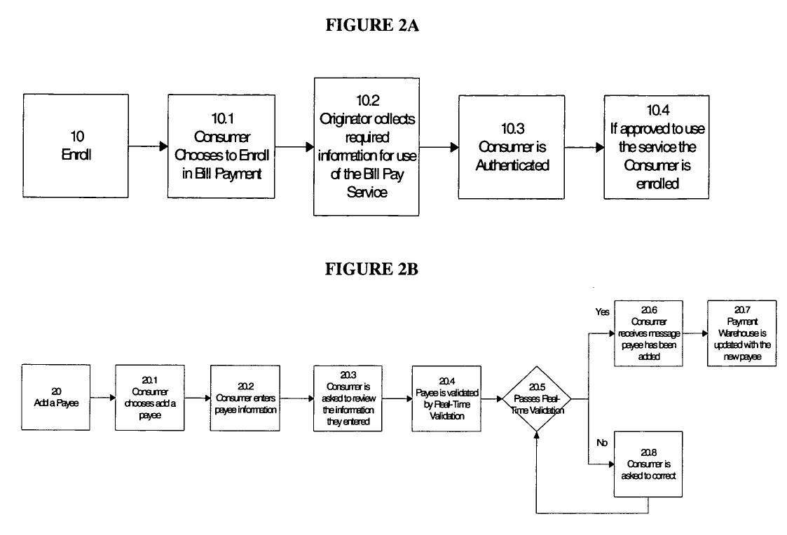

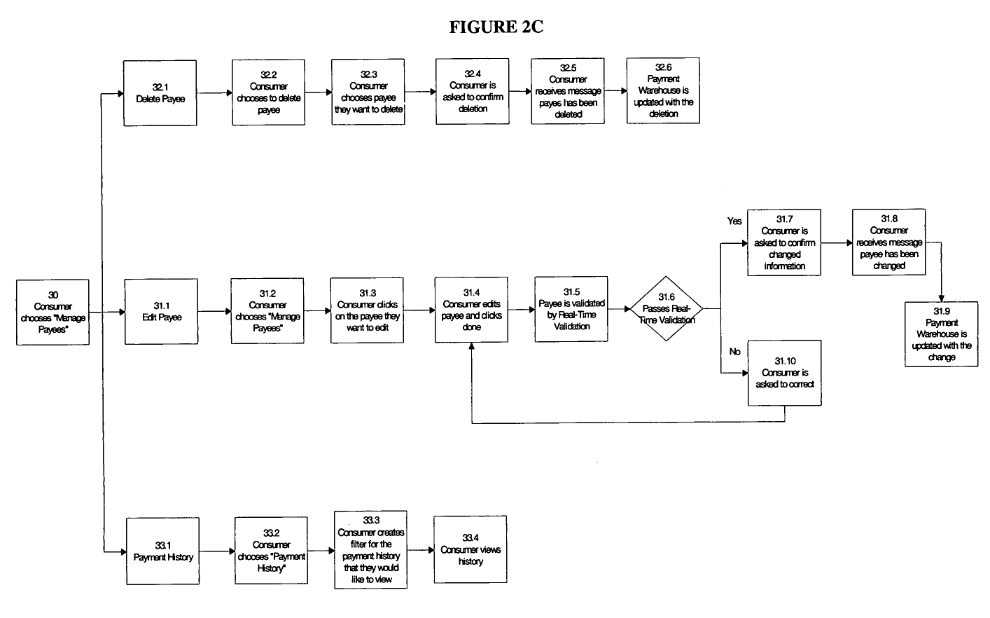

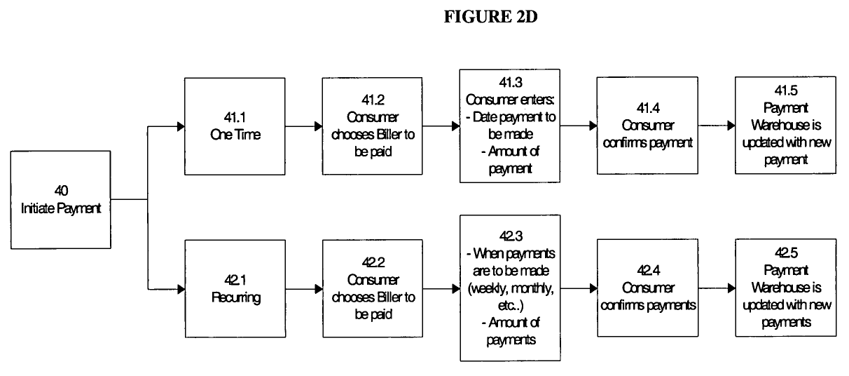

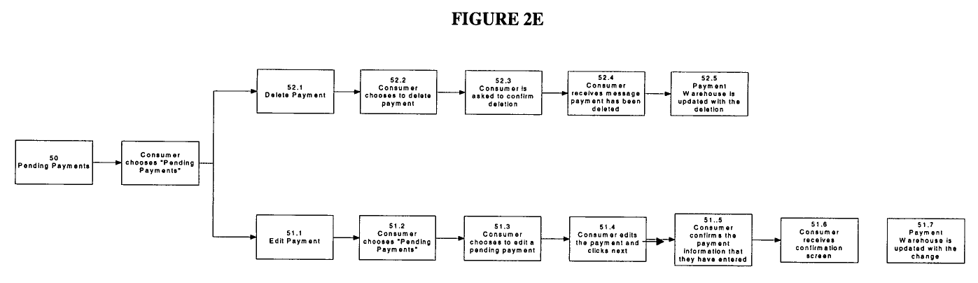

FIGS. 2A-2E provide a further explanation of the individual components illustrated in FIG. 1. FIG. 2A illustrates an exemplary set of functions associated with the Enrollment 10, which facilitates a Consumer enrolling in Bill Pay. FIG. 2B illustrates an exemplary set of functions associated with a Consumer adding a payee 20. FIG. 2C illustrates an exemplary set of functions associated with a consumer managing payees 30. FIG. 2D illustrates an exemplary set of functions associated with initiating a payment 40. FIG. 2E illustrates an exemplary set of functions associated with pending payments 50.

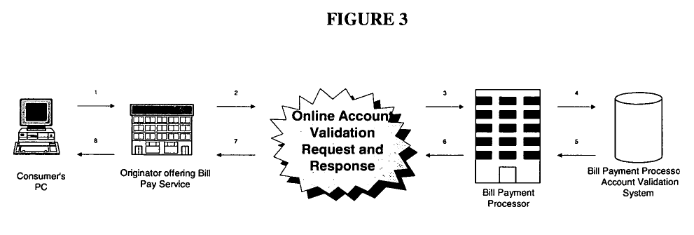

Referring now to FIG. 3, there is illustrated an exemplary system environment for carrying out the present invention. Using FIG. 3, a high level explanation of the process flow of the present invention is provided. The numbers provided above the arrows in FIG. 3 are utilized to facilitate the following explanation.

To begin an online bill payment session, the consumer logs onto their Bill Pay Service with her Originator and requests to add a new payee or update an existing payee to her bill pay service (1). The Bill Pay Service makes a real time call to the Bill Payment Processor to validate the Payee information (2). The Bill Payment Processor captures the real-time request and accesses their Account Validation System to validate the payee information (3). The Account Validation System validates the Payee information based on the account specifications for that Payee (4) and responds (5) with either a success or rejection message. If the response is a rejection, the reason for the rejection is provided to the consumer to allow her to correct the error. The Bill Payment Processor responds to the Bill Pay Service with the results from the Account Validation System (6). The Bill Pay Service receives the response (7). If the response is a success the Bill Payment Warehouse is updated with the addition or change. The Bill Service notifies the Consumer if her change or addition has been accepted (8). If the Payee was validated as a success, she will be told that the addition/change has been done. If the Payee was validated as a reject, she will be told that the Payee information is incorrect and given a reason why it is incorrect, for example, the account length is incorrect. The consumer will then be given the chance to correct the error.

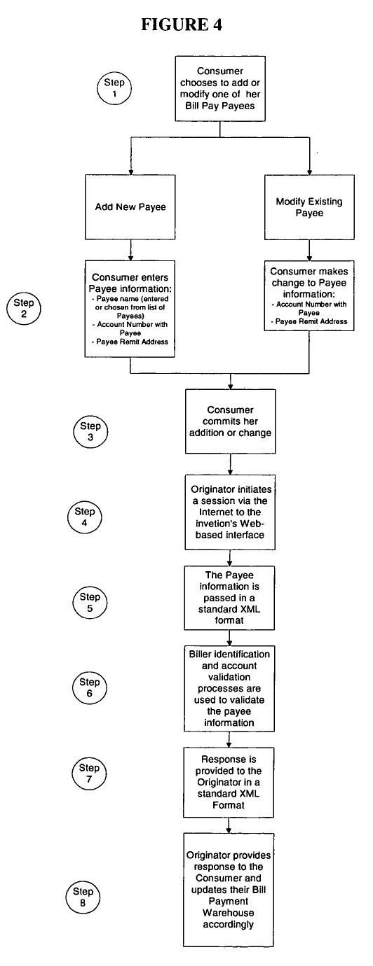

FIG. 4 illustrates an exemplary process flow of the present invention. In Step 1 the consumer has accessed her Internet Bill Pay Service and has chosen to add a new payee or modify an existing payee. Depending on if she is adding a new payee or modifying a payee she will perform a different function. In Step 2 if the consumer is adding a new payee, she will choose a Payee from a list of available Payees or manually enter the Payee name to be added to her profile. It is preferable that the Bill Payment Processor establishes a directory of Payees so the consumer can either pick from the list or manually enter the Payee name. This allows for less manual entry by the consumer, plus it adds the ability for the Bill Payment Processor to validate the payee information more accurately. In addition to the Payee name the consumer enters the Payee's remit address and her account number with the Payee. If the consumer is editing a payee, she is only able to edit the Payee's remit address and her account number with the Payee. As a standard operation, most Internet Bill Pay Services allow the consumer to review the addition or change that she has entered. In Step 3, the consumer has done this and she has “submitted” or “committed” to the change.

It is at this point in Step 4 that the Originator initiates a session to the Bill Payment Processor's Account Validation System. For security purposes, many different types of methods can be used when accessing the system as would be understood by those skilled in the art. One exemplary method that can be utilized is based on the IP address of the Originator's Web page when accessing the validation system. A predefined list of IP addresses are maintained by the Bill Payment Processor and the processor will only allow requests originating from IP addresses on this list. It is to be understood that this method is merely exemplary, is included for illustrative purposes only and should not be construed as limiting the present invention in any fashion.

Originators using a web-based interface could use the standard well-known HTTP (Secured) POST method to access the account number validation of the present invention. In addition, the data stream in the HTTP request can be URL encoded for security purposes or a similar security measure may be put into place. Here again, these methods are merely illustrative and should not be construed as limiting the present invention in any fashion.

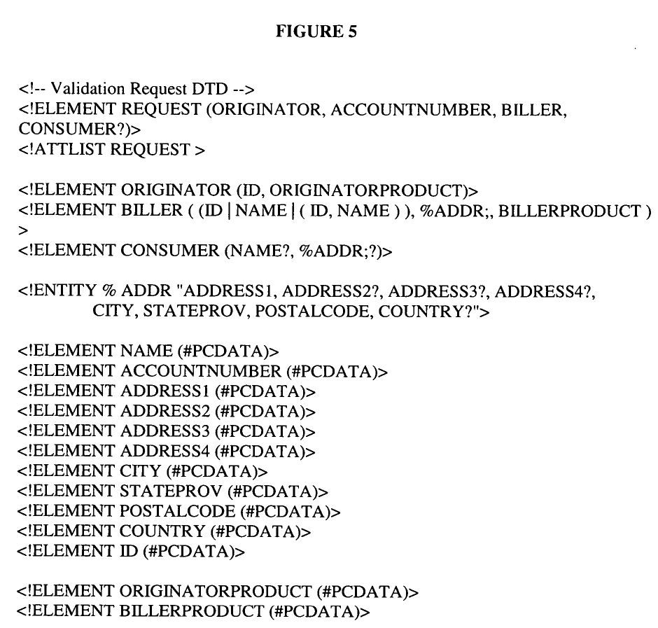

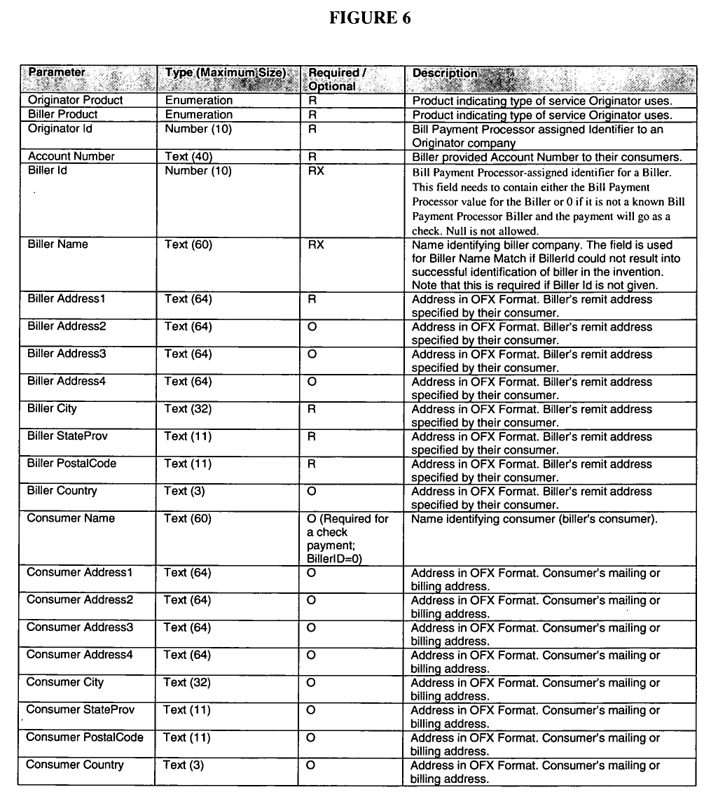

After a secure connection is established, the Payee information is passed in a mutually agreed upon format to the Bill Payment Processor's Account Validation System as shown in step 6 of FIG. 4. The data required for payee validation is based on the Bill Payment Processor and its requirements for account validation, which is well known to those skilled in the art. It is again up to the Bill Payment Processor to establish what data is mandatory or optional. FIG. 5 illustrates an exemplary embodiment of a sample Input Request DTD that can be used to send information to the Bill Payment Processor for validation. FIG. 6 is an exemplary embodiment of a corresponding Input Request Data Dictionary for the Input Request, which defines the tags that are included in the Input Request DTD. It is to be understood that these data formats are merely exemplary, are included for illustrative purposes only and should not be construed as limiting the present invention in any fashion.

Returning to FIG. 4, in Step 6 the Bill Payment Processor's account validation system is called and validates the Payee information that it has been provided. The method of Biller identification differs with each Bill Payment Processors. Bill Payment Processors establish their own method for identification for each payee.

If a match on the Biller is found, the account number is verified to ensure it is compliant with the Biller's account number specifications. Commonly used edits to verify the inputted account number, which are well known to those skilled in the art, include account number masking, plus extensive validation on prefixes, suffixes, check digit algorithms, lengths and remittance addresses. In addition, special cleaning and adjustment routines and lookups against stored account records maintained in the mini-account master file (MAM) are invoked as well. The edits are stored on the Account Validation System of the Bill Payment Processor and are accessed real-time by the Bill Payment Processor of the present invention.

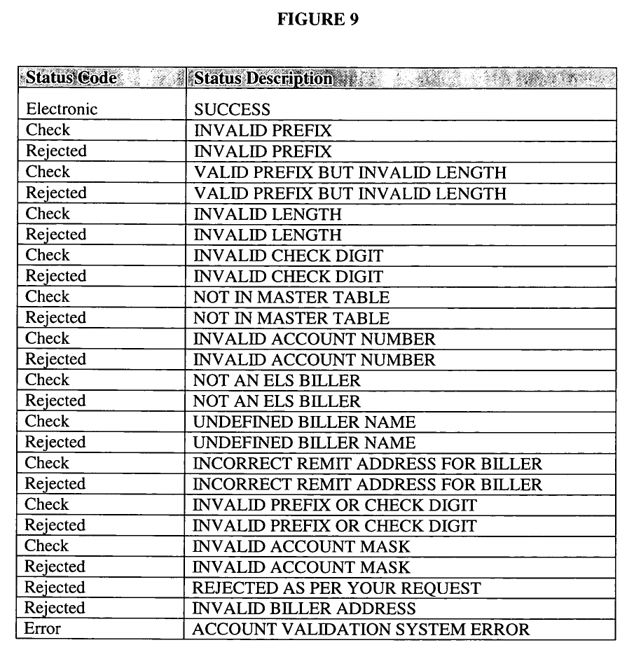

When a Biller's account number or a remittance address is found to be invalid, the present invention can often provide additional information about the error. (See, for example, FIG. 9 for exemplary error reason codes). The information allows the Originator to prompt the customer as to why the error occurred, (e.g., invalid account number) and to allow them to correct the information and resubmit it to be validated.

The present invention may utilize the same validation routines and criteria applied to actual payment file processing. This ensures that a payment that passes real-time validation will actually be sent to the Biller as expected.

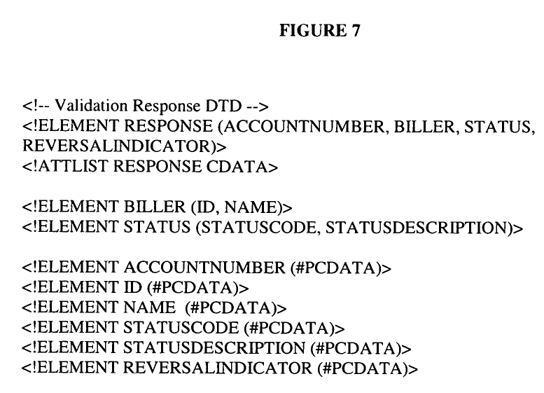

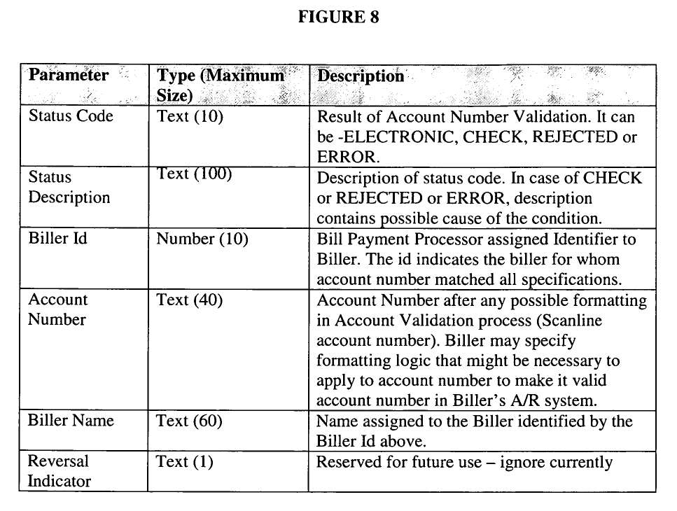

In Step 7 a response data file is provided to the Originator from the Bill Payment Processor. This file notifies the Originator if the Payee information is correct or incorrect by providing a Status Code and Status Description. FIG. 7 illustrates an exemplary Response DTD and FIG. 8 illustrates an exemplary Response Data Dictionary. It is to be understood that these data formats are merely exemplary, are included for illustrative purposes only and should not be construed as limiting the present invention in any fashion. Within the response it is indicated if the payee information is correct or incorrect. FIG. 9, which illustrates examples of different return codes that may be given, is the corresponding Response DTD Data Dictionary for the Response DTD. The Response Data Dictionary illustrated in FIG. 8 defines the tags that are included in the Response DTD. Within the Response DTD there will be information such as a status code and a description that tells if the payee information is correct or rejected or if an error for an electronic payee occurred or if a the payment will be processed as a check. What status codes and descriptions are used depends again on how the Bill Payment Processor performs account validation.

FIG. 9 provides an exemplary embodiment of sample status codes and descriptions that can be used with the invention and how they can be interpreted. It is to be understood that the data formats in FIG. 9 are merely exemplary, are included for illustrative purposes only and should not be construed as limiting the present invention in any fashion. In the exemplary embodiment, here are four values for STATUSCODE: “ELECTRONIC,” “CHECK,” “REJECTED,” and “ERROR” illustrated in FIG. 9. This is not meant to be limiting, as it is well understood by those skilled in the art that additional codes can be utilized. If an “ELECTRONIC” status code is returned in the STATUSCODE field, it means the payment will go electronically and the STATUSDESCRIPTION will contain “SUCCESS”. If a “CHECK” status code is returned in the STATUSCODE field, it means there was an issue that prevents this payment from going electronically such as an invalid account number or invalid address. STATUSDESCRIPTION will contain the reason the payment is prevented from going electronically. The Originator may ask the consumer to resubmit the payee after entering updated information or allow the payee to remain as a check payment Biller. If a “REJECTED” status code is returned in the STATUSCODE field, the Biller will not be accepted because it cannot be disbursed by any method in its current state or because the Originator has asked the Bill Payment Processor not to accept this payee. The Originator is required to ask the consumer to resubmit the payee after entering updated information. One example of why a payment would come back as REJECTED instead of CHECK is if the address entered for the Biller is invalid because a street address is missing. If an “ERROR” status code is returned in the STATUSCODE field, the Bill Payment Processor account validation system is unable to validate the payee. The Originator may advise the consumer to review all of the information submitted, then resubmit the payee after updating information. If the consumer is still having issues she may be prompted to call consumer service.

Returning to FIG. 4, Step 8 is the final step in the account validation process of the present invention. It is completely dependent on how the Originator's Bill Pay Service stores the consumer bill payment information and is within the knowledge of one skilled in the art. The consumer's Bill Pay profile may be updated with the new/edited payee or the consumer may be given immediate notification of the error to allow the consumer to correct the error. How this is done is again dependent on how the Bill Pay Warehouse is updated by the Bill Pay Service. If the consumer corrects the error and submits the change, the process loops back to Step 4 for further processing.

Although the invention has been described and illustrated in the foregoing exemplary embodiments, it is understood that the present disclosure has been made only by way of example, and that numerous changes in the details of construction and combination and arrangement of processes and equipment may be made without departing from the spirit and scope of the invention. The present invention is limited only by the claims which follow.

1. A method for operating an electronic payment system comprising:
(a) receiving a user's payee information;
(b) validating the user's payee information using an account validation system; and
(c) storing the user's payee information only if the validation was a success.

2. The method of claim 1, wherein the user's payee information is received by a bill payment processor of the electronic payment system.

3. The method of claim 2, wherein the bill payment processor includes the account validation system.

4. The method of claim 1, wherein the user's payee information is stored in a bill pay profile of the user.

5. The method of claim 1, wherein the bill pay profile of the user is stored with a service provider of the electronic payment system.

6. The method of claim 1, wherein the user's payee information comprises a payee name selected from a list of previously stored payee names.

7. The method of claim 1, wherein the user's payee information comprises a manually entered payee name.

8. The method of claim 1, wherein the user's payee information comprises a payee name and information identifying the user's account with a payee.

9. The method of claim 8, wherein the user's payee information further comprises a remit address of the payee.

10. The method of claim 1, wherein the user's payee information comprises updated payee information for replacing payee information that was previously stored.

11. The method of claim 10, wherein the updated payee information comprises replacement information for one or more of a payee name, user account information, and a remit address that was previously stored.

12. The method of claim 1, wherein the validating the user's payee information comprises verifying the accuracy of a payee name included in the user's payee information.

13. The method of claim 1, wherein the user's payee information comprises a remit address, and wherein the validating the user's payee information comprises comparing the remit address to a stored remit address of a payee.

14. The method of claim 1, wherein the validating the user's payee information comprises verifying the compliance of account information included in the user's payee information.

15. The method of claim 14, wherein the account information comprises an account number, and wherein the verifying the compliance of the account information comprises checking the account number against account number specifications of a payee.

16. The method of claim 1, further comprising submitting payment to a payee at the request of the user based on the stored payee information.

17. The method of claim 1, further comprising providing error information to the user when the validation of the user's payee information was not a success.

18. The method of claim 17, further comprising receiving new payee information when the validation of the user's payee information was not a success.

19. The method of claim 18, further comprising repeating the validating step and the storing step using the new payee information after it has been received.

20. A method for initiating payment to a biller using an electronic payment system, wherein the payment is based on a user's payee information, the method comprising:
(a) receiving the user's payee information by a bill payment processor of the electronic payment system;
(b) validating the user's payee information using an account validation system of the bill payment processor; and
(c) submitting payment to the biller upon a request by the user if the validation of the user's payee information was a success.

21. The method of claim 20, wherein the submitting payment to the biller comprises either using electronic payment or mailing a financial instrument to a remit address of the biller.

22. A method for operating an electronic payment system comprising:
(a) entering a user's payee information to a service provider of the electronic system;
(b) providing the user's payee information, from the service provider, to a bill payment processor of the electronic payment system;
(c) validating the user's payee information by an account validation system of the bill pay processor;
(d) storing the user's payee information in a bill pay profile of the user only if the validation was a success; and
(e) submitting payment to a payee at the request of the user based on the user's payee information that has been stored in the bill pay profile of the user.

23. An electronic payment system comprising:
a bill payment processor for receiving a user's payee information, the bill payment processor having an account validation system for validating the user's payee information; and
means for providing payment to the payee upon a request by the user if the validation of the user's payee information was a success.
